(19) United States
(12) Patent Application Publication
(10) Pub. No.: US 2010/0325007 A1
(43) Pub. Date: Dec. 23, 2010

(54) System and method for mobile commerce using SMS and voice hybrid communication

(76) Inventor: Satyanarayanan Ramaswamy, Cupertino, CA (US)

Correspondence Address: BRIGHTFON, INC., 7563 HOLLANDERRY PL, CUPERTINO, CA, 95014, US

(21) Appl. No.: 12/803,209

(22) Filed: Jun. 22, 2010

Related U.S. Application Data
(60) Provisional application No. 61/269,301, filed on Jun. 23, 2009.

(51) Int. Cl. G06Q 30/00; H04W 4/12

(52) U.S. Cl. 705/26; 455/466

(57) ABSTRACT

This invention relates in general to mobile commerce, and more specifically to a system and method that uses a combination of SMS messages and voice channel communication to convey user account authentication and/or user account details. By using this invention, sending authentication information of the user over SMS is avoided. The user interacts with the commerce server system by exchanging SMS messages to identify the product he wants to buy and to issue the request to buy the product. To obtain the authentication information from the user, the commerce server system either initiates a voice call to the user or asks the user to call the system. Once the voice call is established, authentication information is obtained over the voice call by the user entering the information on the mobile's keypad and the commerce server system detecting the entered information and completing the commerce transaction if the authentication information is accurate.

### CROSS-REFERENCE TO RELATED APPLICATIONS

PRIORITY IS HEREBY CLAIMED TO EARLIER FILED PROVISIONAL PATENT APPLICATION WITH APPLICATION NUMBER: 61/269,301 WITH FILING-OR-371(c) DATE: Jun. 23, 2009

### FIELD OF THE INVENTION

This invention relates in general to mobile commerce, and more specifically to a system and method that uses a combination of SMS messages and voice channel communication to convey user account authentication and/or user account details. Using this invention, it is possible to consummate a commerce transaction from the mobile without any need for a data plan or a data application on the mobile.

### BACKGROUND OF THE INVENTION

There has been a proliferation of mobile phones with SMS (Short Messaging Support) all around the world. Practically every mobile phone sold in the world supports SMS and normal voice communication. In many parts of the world, the mobile phone is the only link to Internet and e-commerce systems, whether hosted by the mobile network operator or third parties. As a result, mobile-based commerce systems are beginning to be offered in those parts of the world. In these systems, the user is required to download a mobile commerce application which stores the account details such as the credit card number securely in the mobile. When the user wants to consummate a transaction, the account details are transmitted to the servers in the network from the mobile using a data connection. Such a communication between the mobile and the servers takes place over data channels in the mobile cellular network. Many times, this connectivity on the data network is problematic. The user may not have subscribed to a data plan, or the data channel may be congested due to insufficient resource allocation.

In this invention, we present a system and method that uses a combination of SMS and voice communication to convey user account details to the network servers with the objective of consummating a transaction without using any data communication channels. This is useful in geographies where SMS and voice communication is prevalent but data plans are not popular. If just the SMS mechanism is used to send the PIN, the PIN is retained in the SMS message on the ‘Sent SMS’ folder in the mobile. This can potentially be accessed by others and hence poses a security risk. This invention avoids having to send the PIN in an SMS message by using voice channels to communicate the PIN and hence the PIN is not stored anywhere locally on the mobile.

### BRIEF SUMMARY OF THE INVENTION

Consistent with one aspect of the invention, the user interacts with a commerce server via SMS to find the item he wants to buy. This could be done by searching for the item by sending search requests to the commerce server via SMS and getting responses back from the server. Once the user decides to buy an item he sends a ‘buy’ command or equivalent message to the SMS server. The SMS server then sends back a message to the user's mobile asking the user to call a specified phone number to authenticate. When the user calls the number he is connected to an IVR system that asks for the user's authentication details such as the user's PIN (personal identification number). When the user enters the PIN, it is authenticated and if the authentication is a success, this is conveyed to the commerce server for completing the transaction.

Consistent with another aspect of the invention, the user interacts with a commerce server via SMS to find the item he wants to buy. This could be done by searching for the item by sending search requests to the commerce server via SMS and getting responses back from the server. Once the user decides to buy an item he sends a ‘buy’ command or equivalent message to the SMS server. Upon receiving this message, the system initiates a call to the user's phone number and when the user answers the call, he is connected to an IVR system that asks for the user's authentication details such as the user's PIN (personal identification number). When the user enters the PIN, it is authenticated and if the authentication is a success, this is conveyed to the commerce server for completing the transaction.

### BRIEF DESCRIPTION OF THE SEVERAL VIEWS OF THE DRAWINGS

FIG. 1 is an exemplary simplified semi-schematic block diagram of a mobile phone in accordance with this invention.

FIG. 2 is an exemplary simplified semi-schematic block diagram of a network-based commerce server system Server in accordance with this invention.

FIG. 3 is an exemplary simplified block diagram illustrating the communication network that can be used to derive the benefits in accordance with this invention.

### DETAILED DESCRIPTION OF THE INVENTION

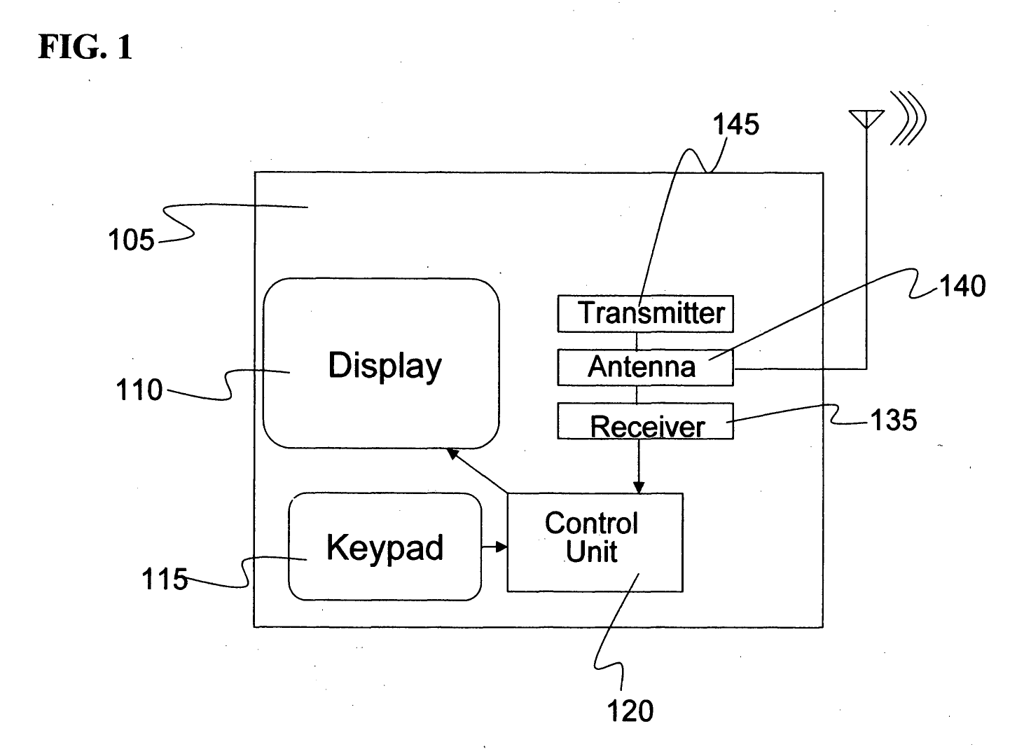

FIG. 1 presents a simplified semi-schematic block diagram of a mobile phone 105 operable in accordance with this invention. As illustrated in FIG. 1, the mobile phone consists of a display 110 that is used to display system responses and messages to the user. The mobile phone also has a keypad 115 used to obtain user-typed inputs to the system, such as specific keys to be pressed in response to system messages. This keypad could be a physical keypad or it could be a soft keypad which is displayed on a touch sensitive display 110 and whose keys are activated by the user touching the appropriate displayed key. Pressing the keys in the keypad while the mobile is on a voice call generates DTMF tones that can be decoded by the network elements to decipher the key that was pressed. The mobile phone has a control unit 120 that controls all other parts of the mobile phone with either software and/or hardware commands. The mobile phone-side logic of the system as embodied in this invention is performed by this control unit. The control unit is also connected to a wireless receiver 135, antenna 140 and a transmitter 145 that are used to communicate with the Application Server system using either voice or data communication channels. Any one of a variety of wireless technologies can be used to provide the communication link to/from the mobile phone, the only key requirement being that the communication link used by the mobile phone is wireless and supports voice and SMS communication.

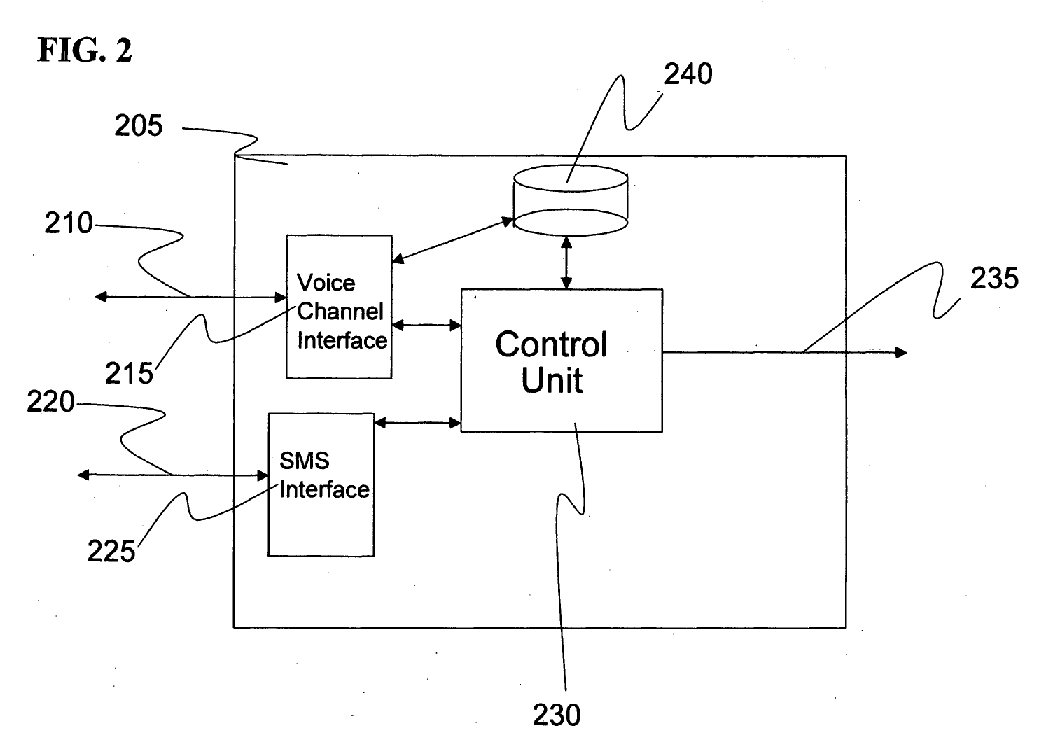

FIG. 2 presents a simplified semi-schematic block diagram of a Commerce Application Server system 205 operable in accordance with this invention. This system consists of a voice communication link 210 that is used to connect with a plurality of mobile phones 105 via communication links carrying voice signals. The Commerce Application Server system is connected to the voice communication link via a voice channel interface 215 that interfaces the Application Server system with the communication link to receive and originate voice calls. The Application Server system 205 also consists of a SMS communication link 220 that is used to connect with a plurality of mobile phones 105 via communication links carrying data signals. The Commerce Application Server system is connected to the SMS communication link via a SMS channel interface 225 that interfaces the Commerce Application Server system with the communication link to receive and originate SMS messages. The Commerce Application Server system is controlled by a control unit 230 that performs the network logic of the system as embodied in this invention and that controls the other components of the Application Server system. It will be evident to one with skill in the art that the schematic in FIG. 2 is only indicative of the functionality required and is not prescriptive of any specific hardware or software architecture. The components of this functional schematic can be distributed across multiple distributed physical servers and/or modularized along specific roles required to be performed by the control unit 230 The mobile phone 105 can access the Commerce Application Server system 205 over the voice channels by initiating a voice calls to a phone number, hereafter referred to as “System Phone Number”. Likewise, the Commerce Application server system 205 can initiate a call to the mobile phone 105 over the voice channels. The voice channel interface 215 and the control unit 230 can access an authentication database 240 to authenticate the credentials entered by the user via the mobile.

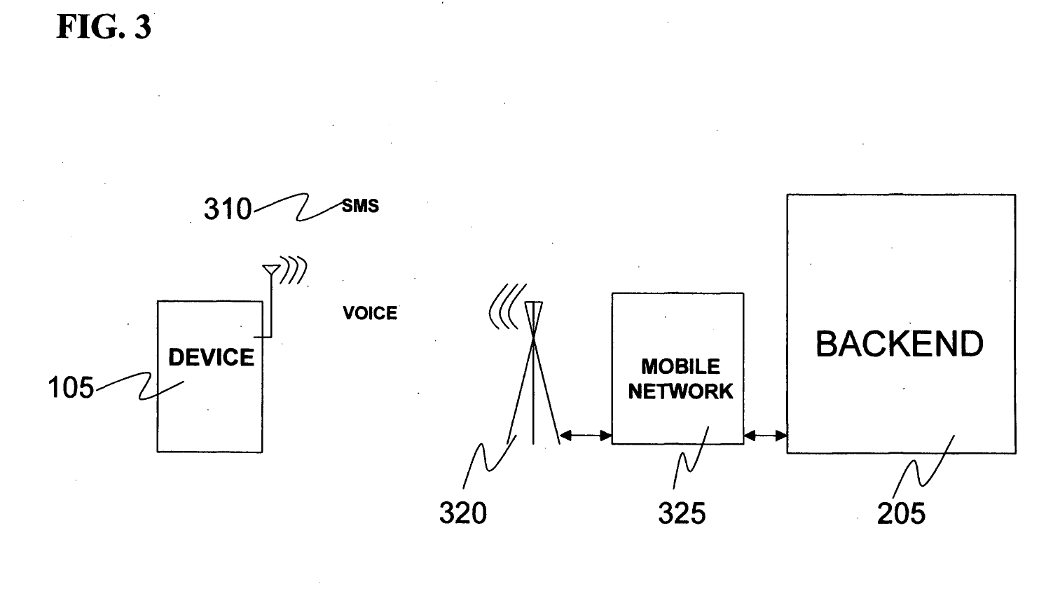

FIG. 3 illustrates a possible embodiment of the link that connects the mobile phone 105 with the Application Server system 205. This link could either be a voice communication channel such as those found in any cellular mobile technology, such as CDMA, GSM, UMTS, etc, or it could be a SMS communication channel that carries SMS messages on them. The only requirement on this communication channel is that it should be able to carry any voice signal and SMS messages between the mobile phone 105 and the Commerce Application Server system 205. For automatically identifying the mobile, it is preferred that the voice channel also be able to carry Calling Line Identification (CLI) information.

Operation of a particular embodiment in accordance with the practice of principles of this invention will be described below. When the user wants to buy an item, he initiates an SMS based dialog with the Commerce Application Server using SMS messages. For example, he may send an SMS message to the Commerce Application Server with a command to search for a particular item. The Commerce Application Server responds back with one or more items matching the request by the user. When the user wants to buy an item, he sends back an SMS message to the Commerce Application Server with a corresponding command and either an explicit or an implicit indication of the item to be bought. For example, the user may text back saying ‘buy’ or ‘buy xx’ where xx is a notation indicating the specific item the user desires to buy. When the Commerce Application Server receives this request, it responds back with a message on SMS asking the user to call the ‘System Phone Number’ to authenticate the purchase request. Upon receiving this message, the user calls the System Phone Number. Upon receiving the call, the Voice Channel Interface 215 either automatically detects the user account from the caller id or asks the user to enter the account number. Then the Voice Channel Interface 215 asks the user to enter a PIN or such authentication code. The user enters this code using the keypad 115 and this information is conveyed on the voice channel using DTMF signals or other signaling means to the Voice Channel Interface 215. The Voice Channel Interface either authenticates this information using the Authentication Database 240 or passes this authentication code to the Control Unit 230 for authentication. If the authentication information entered by the user is correct, then the Commerce Application Server completes the purchase transaction for the user. Otherwise the user is asked to reenter the information. Note that in this interaction, the authentication information is never sent over the SMS channel, and hence is not stored anywhere on the mobile. The information sent over the voice channel is transient and hence cannot be accessed by others from the mobile.

Operation of another embodiment in accordance with the practice of principles of this invention will be described below. When the user wants to buy an item, he initiates an SMS based dialog with the Commerce Application Server using SMS messages. For example, he may send an SMS message to the Commerce Application Server with a command to search for a particular item. The Commerce Application Server responds back with one or more items matching the request by the user. When the user wants to buy an item, he sends back an SMS message to the Commerce Application Server with a corresponding command and either an explicit or an implicit indication of the item to be bought. For example, the user may text back saying ‘buy’ or ‘buy xx’ where xx is a notation indicating the specific item the user desires to buy. When the Commerce Application Server receives this request, it initiates a call to the mobile number from which the SMS message was received. When the user answers the call, the Voice Channel Interface 215 asks the user to enter a PIN or such authentication code. The user enters this code using the keypad 115 and this information is conveyed on the voice channel using DTMF signals or other signaling means to the Voice Channel Interface 215. The Voice Channel Interface either authenticates this information using the Authentication Database 240 or passes this authentication code to the Control Unit 230 for authentication. If the authentication information entered by the user is correct, then the Commerce Application Server completes the purchase transaction for the user. Otherwise the user is asked to reenter the information. Note that in this interaction, the authentication information is never sent over the SMS channel, and hence is not stored anywhere on the mobile. The information sent over the voice channel is transient and hence cannot be accessed by others from the mobile.

What is claimed is:

1. A system and method for mobile commerce using SMS and voice hybrid communication wherein user authentication information is carried over only voice channels, the system comprising of a mobile terminal and a commerce server system, the method comprising of the user identifying the product he wants to buy by exchanging SMS messages with the commerce server system and then issuing a command in an SMS message to the commerce server system to buy the product, the commerce server system sending a response SMS message back asking the user asking him to call a specific phone number, and upon the user calling that number, asking the user to enter the authentication information while in the voice call, detecting the user entered information, and completing the commerce transaction if the authentication information is accurate.

2. A system and method for mobile commerce using SMS and voice hybrid communication wherein user authentication information is carried over only voice channels, the system comprising of a mobile terminal and a commerce server system, the method comprising of the user identifying the product he wants to buy by exchanging SMS messages with the commerce server system and then issuing a command in a SMS message to the commerce server system to buy the product, the commerce server system calling the user on the mobile number from where SMS messages were exchanged, and upon the user answering the call, asking the user to enter the authentication information while in the voice call, detecting the user entered information, and completing the commerce transaction if the authentication information is accurate.
